(19) United States
(12) Patent Application Publication
(10) Pub. No.: US 2025/0148038 A1
(43) Pub. Date: May 8, 2025

(54) PAIRWISE LABELLING TO CAPTURE SUBJECTIVE ESTIMATES

(71) Applicant: Schlumberger Technology Corporation, Sugar Land, TX (US)

(72) Inventor: Pontus Loviken, Clamart (FR)

(21) Appl. No.: 18/941,732

(22) Filed: Nov. 8, 2024

Related U.S. Application Data
(60) Provisional application No. 63/597,172, filed on Nov. 8, 2023.

(51) Int. Cl. G06F 16/958; G06F 3/0482

(52) U.S. Cl. CPC G06F 16/958; G06F 3/0482

(57) ABSTRACT

Systems and methods of the present disclosure are configured to enable human annotators to quickly, and potentially in groups, annotate thousands of data points of content, so that each data point of content gets a value with respect to some attribute, so that data points of content showing more of the attribute have higher values than those showing less of the attribute. For example, a method includes presenting two content items of a plurality of content items via a user interface of a web-based application; receiving, via the user interface of a web-based application, an annotation relating to an indication of which of the two content items are associated with a criterion; and updating a score relating to the criterion for each of the plurality of content items based at last in part on the annotation.

### CROSS-REFERENCE TO RELATED APPLICATIONS

This application claims priority to U.S. Provisional Application No. 63/597,172, filed on Nov. 8, 2023, which is incorporated herein by reference in its entirety.

### BACKGROUND

The present disclosure relates to systems and methods for enabling human annotators to quickly, and potentially in groups, annotate thousands of data points of content, so that each data point of content gets a value with respect to some attribute, so that data points of content showing more of the attribute have higher values than those showing less of the attribute.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as an admission of any kind.

There are many instances where it is desirable to assign relative values to content items (such as images, videos, audio signals, and so forth) by some attribute for which human feedback is needed to ascertain. This could be to determine how happy a face looks in an image or video, how safe a workplace looks in an image or video, the quality of a measurement, to what extent smoke is visible in an image or video, how aggressive a voice sounds in a video or an audio signal, how expensive a tool looks in an image or video, and so forth.

Being able to place values on content items by such subjective criteria have many advantages. For example, it allows the content items to be sorted by the presence of the property, and it also provides labels for machine learning techniques that can be trained to look at new content items and approximate what score human annotators would have given them.

A big challenge for this endeavour is that it is often hard or impossible for annotators to put absolute values on the presence of an attribute on a content item. It is often much easier to compare two content items and say which one has more of the attribute. This fact may be used to create an annotation interface where human annotators instead compare content data points two and two, and only need to indicate the one with more of the attribute or indicate that it is too similar to determine. What two content items will be compared may be based on previous annotations so that the new judgment will be the most informative possible.

### SUMMARY

A summary of certain embodiments described herein is set forth below. It should be understood that these aspects are presented merely to provide the reader with a brief summary of these certain embodiments and that these aspects are not intended to limit the scope of this disclosure.

Certain embodiments of the present disclosure include a method that includes presenting two content items of a plurality of content items via a user interface of a web-based application. The method also includes receiving, via the user interface of a web-based application, an annotation relating to an indication of which of the two content items are associated with a criterion. The method further includes updating a score relating to the criterion for each of the plurality of content items based at last in part on the annotation.

Various refinements of the features noted above may be undertaken in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings, in which:

FIG. 1 is a schematic of a content analysis and processing system implemented in a client-server architecture, in accordance with embodiments of the present disclosure;

FIG. 2 illustrates various types of content items that may be annotated, in accordance with embodiments of the present disclosure;

FIG. 3 illustrates an example user interface of a web-based application, which may be displayed on a client device to enable an annotator to make comparisons of various content items, in accordance with embodiments of the present disclosure; and

FIG. 4 illustrates the convergence of different algorithms, in accordance with embodiments of the present disclosure.

### DETAILED DESCRIPTION

One or more specific embodiments of the present disclosure will be described herein. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As used herein, the terms “connect,” “connection,” “connected,” “in connection with,” and “connecting” are used to mean “in direct connection with” or “in connection with via one or more elements”; and the term “set” is used to mean “one element” or “more than one element.” Further, the terms “couple,” “coupling,” “coupled,” “coupled together,” and “coupled with” are used to mean “directly coupled together” or “coupled together via one or more elements.” As used herein, the terms “up” and “down,” “uphole” and “downhole”, “upper” and “lower,” “top” and “bottom,” and other like terms indicating relative positions to a given point or element are utilized to more clearly describe some elements. Commonly, these terms relate to a reference point as the surface from which drilling operations are initiated as being the top (e.g., uphole or upper) point and the total depth along the drilling axis being the lowest (e.g., downhole or lower) point, whether the well (e.g., wellbore, borehole) is vertical, horizontal or slanted relative to the surface.

In addition, as used herein, the terms “real time”, “real-time”, or “substantially real time” may be used interchangeably and are intended to described operations (e.g., computing operations) that are performed without any human-perceivable interruption between operations. For example, as used herein, data relating to the systems described herein may be collected, transmitted, and/or used in control computations in “substantially real time” such that data readings, data transfers, and/or data processing steps occur once every second, once every 0.1 second, once every 0.01 second, or even more frequent, during operations of the systems (e.g., while the systems are operating). In addition, as used herein, the terms “automatic” and “automated” are intended to describe operations that are performed are caused to be performed, for example, by a control system (i.e., solely by the control system, without human intervention).

Certain organizations may generate and manage a large quantity of content, which the organizations may wish to analyze to, for example, identify when the content is indicative of certain information. With this in mind, present embodiments are directed to a content analysis and processing system that enables human annotators to quickly, and potentially in groups, annotate thousands of data points of content, so that each data point of content gets a value with respect to some attribute, so that data points of content showing more of the attribute have higher values than those showing less of the attribute.

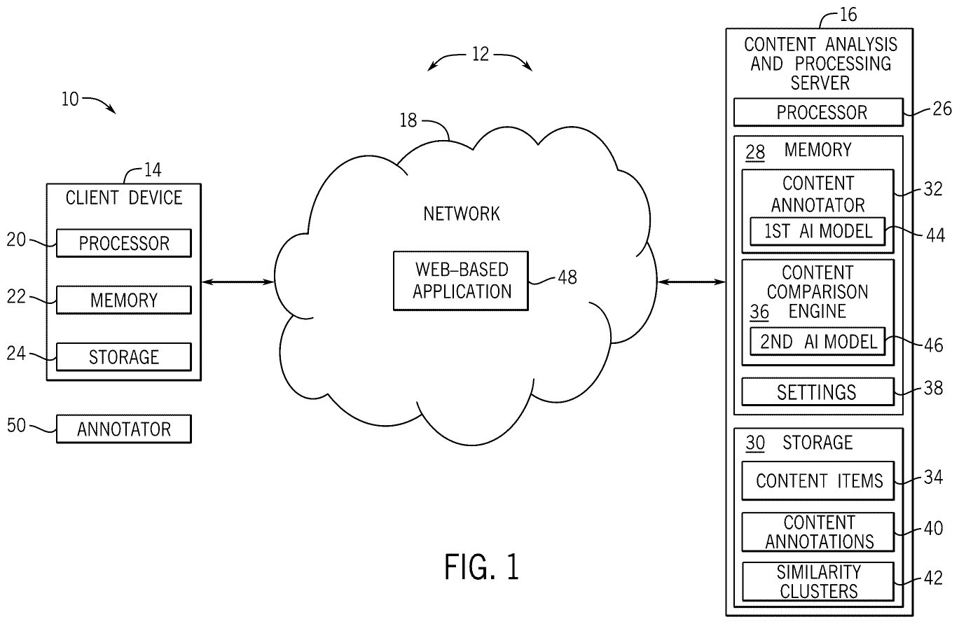

With the foregoing in mind, FIG. 1 is a schematic of a content analysis and processing system 10 implemented in a client-server architecture 12. For the illustrated embodiment, the content analysis and processing system 10 includes a client device 14 that is communicatively coupled to a content analysis and processing server 16 via a suitable network 18 (e.g., a local area network, a wide area network, a virtual private network, the internet). While the illustrated content analysis and processing system 10 is implemented in a client-server architecture 12, in other embodiments, the content analysis and processing system 10 may be implemented within a cloud-based architecture, or within a single (e.g., local, stand-alone) computing system.

For the embodiment illustrated in FIG. 1, the client device 14 includes at least one processor 20 (e.g., processing circuitry, a central processing unit (CPU), a graphics processing unit (GPU)), at least one memory 22 (e.g., random access memory (RAM), read-only memory (ROM), non-transitory computer-readable media), and at least one storage 24 (e.g., solid state disk, hard drive, flash drive). The memory 22 and/or storage 24 of the client device 14 stores instructions that are executed by the processor 20 to enable the client device 14 to perform desired functions, including providing requests to the content analysis and processing server 16, and receiving responses from the content analysis and processing server 16, via the network 18. For example, in some embodiments, the client device 14 may store and execute an internet browser to enable the user to interact with the content analysis and processing server 16.

Similarly, the content analysis and processing server 16 includes at least one processor 26 (e.g., processing circuitry, a CPU, a GPU), at least one memory 28 (e.g., RAM, ROM, non-transitory computer-readable media), and at least one storage 30 (e.g., solid state disk, hard drive, flash drive). The memory 28 and/or storage 30 of the content analysis and processing server 16 stores instructions that may be executed by the processor 26 to enable the content analysis and processing server 16 to perform the methods described in greater detail herein. In particular, the memory 28 or storage 30 of the content analysis and processing server 16 may store a content annotator 32 that is designed and implemented to apply annotations to content items 34 that are stored in the storage 30, as described in greater detail herein. The memory 28 or storage 30 of the content analysis and processing server 16 may also store a content comparison engine 36 that is designed and implemented to receive and store comparison scores selected by users (e.g., content annotators), as described in greater detail herein. The memory 28 of the content analysis and processing server 16 may also store settings 38 that are configured by a user and are used by the content annotator 32 and/or the content comparison engine 36 during operation, as described in greater detail herein. The storage 30 or the memory 28 of the content analysis and processing server 16 may store the content items 34, content annotations 40 determined by the content annotator 32 for the content items 34, and similarity clusters 42 determined by the content comparison engine 36 for the content items 34.

As noted above, the content annotator 32 may be designed and implemented to enable annotations to the content items 34 by, for example, receiving comparisons of content items 34 selected by users. In addition, in certain embodiments, the content annotator 32 may include a first artificial intelligence (AI) model 44 (e.g., a neural network model) that may be trained and/or fine-tuned to determine trends with the annotations, which may be used as described in greater detail herein. In addition, in certain embodiments, the content comparison engine 36 may include a second AI model 46 that may be trained and/or fine-tuned to utilize the information learned by the first AI model 44 to automatically (e.g., without human intervention) annotate future content items 34 based on the learned information.

In certain embodiments, the possible types of annotations to be identified may be relevant to a particular domain (e.g., a technology or business space) associated with a client, and these may be defined by a user and stored within the settings 38 of the content analysis and processing server 16. For example, for an oil and gas client, possible types of annotations may relate to, but are not limited to: petrophysics, dynamic performance, past exploration history, fluid drilling history, past production history, chemistry, storage capacity, deployment planning, and contract/legal discussions.

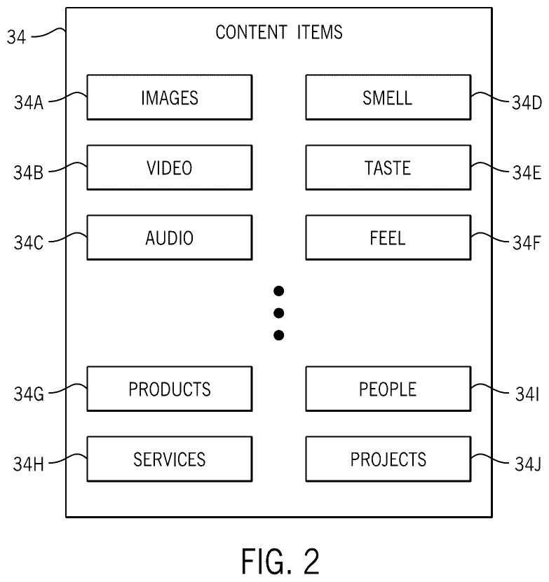

FIG. 2 illustrates various types of content items 34 that may be annotated using the techniques described in greater detail herein. As illustrated in FIG. 2, in certain embodiments, the content items 34 may include images 34A that may depict certain visual criteria (e.g., which may be grouped into categories) for annotation by users. For example, a user may be asked which image 34A between two images 34A includes the happier of two people, or a user may be asked which image 34A of two images 34A includes more smoke, or a user may be asked which image 34A of two images 34A includes a safer looking work environment, among other criteria. Indeed, any possible criteria of interest relating to certain features depicted by two images 34A may be compared by any number of users, and the results of all of the comparisons of the two images 34A, as well as any other images 34A similarly compared by users, may be used to determine which of the images 34A have “more” of the criteria of interest.

As also illustrated in FIG. 2, in certain embodiments, the content items 34 may include video streams 34B that may depict certain visual criteria (e.g., which may be grouped into categories) and/or provide audio relating to audible criteria (e.g., which may also be grouped into categories) for annotation by users. For example, similar to the images 34A, a user may be asked which video stream 34B between two video streams 34B includes the happier of two people, or a user may be asked which video stream 34B between two video streams 34B includes more smoke, or a user may be asked which video stream 34B between two video streams 34B includes a safer looking work environment, among other things. In addition, a user may be asked which video stream 34B between two video streams 34B includes an angrier sounding voice, or a user may be asked which video stream 34B between two video streams 34B seems the most peaceful from a sound perspective, or a user may be asked which video stream 34B between two video streams 34B includes a machine having an audibly-perceived defect, among other criteria. Indeed, any possible criteria of interest relating to certain features depicted by two video streams 34B or included as audio in the two video streams 34B may be compared by any number of users, and the results of all of the comparisons of the two video streams 34B, as well as any other video streams 34B similarly compared by users, may be used to determine which of the video streams 34B have “more” of the criteria of interest.

As also illustrated in FIG. 2, in certain embodiments, the content items 34 may include audio streams 34C that may depict certain visual criteria (e.g., which may be grouped into categories) and/or provide audio relating to audible criteria (e.g., which may also be grouped into categories) for annotation by users. For example, similar to the video stream 34B, a user may be asked which audio stream 34C between two audio streams 34C includes an angrier sounding voice, or a user may be asked which audio stream 34C between two audio streams 34C seems the most peaceful from a sound perspective, or a user may be asked which audio stream 34C between two audio streams 34C includes a machine having an audibly-perceived defect, among other criteria. Indeed, any possible criteria of interest relating to certain features in the two audio streams 34C may be compared by any number of users, and the results of all of the comparisons of the two audio streams 34C, as well as any other audio streams 34C similarly compared by users, may be used to determine which of the audio streams 34C have “more” of the criteria of interest.

In addition, in certain embodiments, other types of content items 34, other than visual or audible content items 34, may be compared by users. For example, in certain embodiments, different smells 34D may be presented to the users, for example, using certain systems configured to recreate certain smells of interest. Alternatively, in other embodiments, users may be presented with physical samples (e.g., perfumes) that have smells to be compared by the users. In addition, in certain embodiments, different tastes 34E may be presented to the users, for example, by providing the users with consumable samples (e.g., food or drinks) that have tastes to be compared by the users. In addition, in certain embodiments, different samples having particular physical feel 34F may be presented to the users, such that the users may compare what it feels like to touch the samples.

Indeed, it will be appreciated that almost anything capable of comparison may be presented to users. For example, in certain embodiments, users may be asked about certain criteria relating to certain products 34G, for example, which of two products are the users more likely to buy. In addition, in certain embodiments, users may be asked about certain criteria relating to certain services 34H, for example, which repair shop do the users think provides better overall service. In addition, in certain embodiments, users may be asked about certain criteria relating to certain people 34I to, for example, be used as part of personnel evaluation where the users may be asked which employees' performance are they more pleased with. In addition, in certain embodiments, users may be asked about certain criteria relating to certain projects 34J, for example, which project do the users feel has the best potential for success.

Returning to FIG. 1, the storage 30 of the content analysis and processing server 16 may function as a database that includes, among other data:
An ordered list of content items 34 to be annotated. Each content item 34 may be represented by its order in the list.
One folder for each criterion by which the content items 34 should be annotated.
In each such folder, there may be a file for each annotator (e.g., user), containing a list of comparisons that the annotator has made with respect to that criterion.

For example, if images 34A of faces are annotated by “age” by an annotator “Eric”, there may be a folder called “age”, with a text file called “Eric”. In this text file, there may be a list of judgments Eric has made. Each judgment is of the form i>j, i=j or i<j, where i and j are the indices of content items 34 that have been compared by Eric. If Eric compared image 1 and image 2 and said that the face of image 1 looked older than the face of image 2, that results in the comparison 1>2 in Eric's list, in the folder “age”.

### Front End

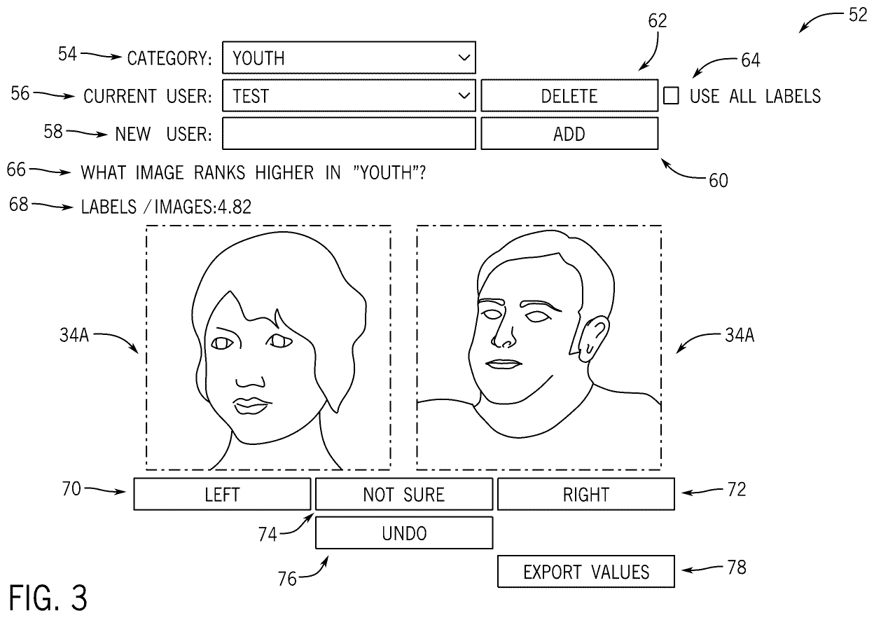

FIG. 1 also illustrates a web-based application 48 that may be provided by the content analysis and processing server 16 to client devices 14 to enable annotators 50 to make comparisons of various content items 34, as described in greater detail herein. FIG. 3 illustrates an example user interface 52 of the web-based application 48, which may be displayed on a client device 14 to enable an annotator 50 to make comparisons of various content items 34. First, an annotator 50 may choose a Category 54 by which the content items 34 (e.g., images 34A in the illustrated embodiment) will be labelled. In addition, in certain embodiments, the annotator 50 may select themselves as the Current User 56. It will be appreciated that, in certain embodiments, the web-based application 48 may already know that the particular annotator 50 is the current user, for example, based on login credentials, and may automatically set the particular annotator 50 as the Current User 56. In addition, in certain embodiments, to just try the web-based application 48 out, there may be a user choice “−”, which will lead to no annotations being saved. In addition, in certain embodiments, if the annotator 50 has not already done annotation in this Category 54, a new user may be added in a New User box 58, followed by clicking an Add button 60. In addition, in certain embodiments, an annotator 50 may remove themselves using a Delete button 62.

In addition, in certain embodiments, a Use All Labels checkbox 64 may be selectable, the importance of which will be described in greater detail below. In addition, in certain embodiments, plain language text 66 may be provided to explain the specific criteria for annotation, together with the current progress 68, which may indicate how many times each content item 34 has been annotated. Two content items (e.g., two images 34A in the illustrated embodiment) are shown via the user interface 52 next to each other. If dealing with video streams 34B or audio streams 34C, there may be a button that allows the streams 34B, 34C to be played when clicked upon.

The annotator 50 may select the image 34A (or other content item 34) that ranks higher on the chosen criteria (e.g., by selecting a Left button 70 corresponding to the left image 34A or a Right button 72 corresponding to the right image 34A), and if the annotator 50 is unable to decide, a Not Sure button 74 may instead be selected. In addition, in certain embodiments, if a mistake is made, the annotator 50 may select an Undo button 76 to undo the annotation. In addition, in certain embodiments, an Export Values button 78 may enable annotators 50 to extract scores for each content item 34.

### Back End

Each time an annotator 50 selects the Left button 70, the Right button 72, or the Not Sure button 74, the relationships may be saved at the end of the list of the current content annotations 40 (e.g., illustrated in FIG. 1). If the annotator 50 selects the Undo button 76, the last comparison in that list is removed, and the annotated images 34A are once again showed to allow for another outcome. All content items 34 are given a score using all previous comparisons of the current Category 54, unless the Use All Labels checkbox 64 is ticked. Then, the labels of all annotators 50 of the Category 54 may be used when computing the scores. These scores may be computed using some error minimization techniques to have the greatest possible agreement with the collected comparisons.

Using the scores of all data points, the two data points to choose between are selected so that the label of the Category 54 will be the most informative, in order to have the most accurate scores with the least amount of labels. One might imagine many ways to do this. Generally it could, however, mean to pair up data points with similar scores, as this is where the relationships are the least known. It would also mean that data points with few comparisons are more likely to be selected as less annotations means higher uncertainty. Once additional annotations do not change the scores anymore, the value of each content item 34 may be presumed to have been found for the given Category 54, or for all Categories 54 (if the Use All Labels checkbox 64 is ticked).

It should be noted that the Use All Labels option may be useful in a couple of ways. For example, if an annotator 50 hasn't labelled many content items 34, the algorithm is able to give comparisons that are close in attribute, based on the feedback from other annotators 50. In that case, an annotator 50 could, for example, see that they select “Not Sure” all the time, which will tell them that no further labelling is necessary. Or, if the new annotator 50 has a slightly different taste then the rest of the annotators 50, they will be able to make an impact where it matters the most, as they can see a difference where the other annotators 50 couldn't. This can also be powerful if the “other labeller” is the AI model 46 described herein. The annotator 50 can then quickly determine if they agree with that algorithm, and if not, after having annotated enough images with Use All Labels selected, they can turn it off, and simply continue until they have a new ranking reflecting their own taste (this applies when the other labellers are humans, as well). In the AI case, the new scores could in turn then be used to retrain the AI models 44, 46.

It should be noted that the ranking for one attribute of one annotator 50 might not be the same as for another annotator. This means that when adding all labels together, the ranking may be a compromise between different tastes. One way to really see this compromise in action is to mix labels of different categories (e.g., youth and image quality), which corresponds to two annotators 50 understanding their task completely differently. Still, even in this case, the compromise is decent, so in all realistic cases where annotators 50 label more or less the same, it should be even better.

### Example Use Case

A stakeholder has a set of images 34A they want to annotate by some attributes “A” and “B”.
The stakeholder upload the images 34A to the web-based application 48, together with attribute names.
The stakeholder collects experts willing to annotate their data. The stakeholder assigns each annotator 50 a category 54, and gives them a goal of labels/expert (or labels together if there are too many images 34A for accurate scores to be computed from the labels of a single annotator 50).
Each annotator 50 logs into the web-based application 48, selects their category 54 and adds their name (and selects it).
The annotators 50 then look at the pairs of images 34A and choose which one has more of the attribute they are evaluating. If unsure, they indicate so.
The more they annotate, the harder the task becomes, since previous annotations give increasingly accurate scores, making new pairs more similar.
Once each annotator 50 has done their share, they tell the organizer stakeholder, which can then extract scores to all the images 34A, either scores from each annotator 50, or a global score using the labels from all of the annotators 50. If collecting the scores of each annotator 50, they can be compared with each other.

The stakeholder can then use the scores to order their data points, train machine learning models, and so forth.

For example, as described above, in certain embodiments, the results of the annotations can be used to train a first AI model 44 to determine trends with the annotations. Then, the results of the first AI model 44 may be used to train a second AI model 46 to utilize the information learned by the first AI model 44 to automatically (e.g., without human intervention) annotate future content items 34 based on the learned information.

In addition, in certain embodiments, the content analysis and processing system 10 may also be configured to detect errors in labelling by certain annotators 50. For example, a comparison may be made between asking people for their age and approximating their age by looking at them (or a real sensor, and a human eyeballing it). The first is clearly more accurate. However, sensors might make errors, people might lie about their age, and so forth. By also collecting impressions from annotators 50, as described in greater detail herein, a different, independent model (e.g., the second AI model 46), which can identify when the first AI model 44 fails, may be obtained. As an illustrating example, an old woman might say that she (or someone else) is very young, but the second model may say that this is not true, even though it is unable to guess the true age exactly.

### Notation

The goal is to convert pairwise comparisons of the type: {i*j}, where i and j are content items 34, and *∈[<, =, >] (“worse than”, “equal to”, “better than”), into scores {sᵢ, sⱼ, . . . } so that sᵢ>sⱼ if i is generally deemed “better than” j, and sᵢ≈sⱼ if they are generally deemed “equal”, or the chance P(i>j)≈P(j>i), where P(i*j) denotes the chance that i*j in a single comparison.

These comparisons can represent many different content items 34. For example, if i, j are chess players, then P(i>j) is the probability that i will beat j in a match, P(i=j) is the probability that they play a draw, and {i>j} would represent a single outcome, where i won over j. In another case, i, j might represent two different images 34A, and an outcome {i>j} would represent that an annotator 50 preferred i to j for some given quality.

Over time, a list Lₙ={oᵢ}ᵢ₌₀ⁿ of outcomes of oᵢ={i₁*i₂} is created. From this list, compute values n_{i*j} may also be computed, which is the number of times i*j were observed, and nᵢⱼ is the total number of times i and j has been compared. Once again, * is a place holder for the three possible outcomes {<, =, >}. Note that:

$$\begin{matrix}{lim}_{{n}_{ij} \to ∞} [ \frac{{n}_{i * j}}{{n}_{i j}} ] \to P ( i * j ) \\ i > j ⇔ j < i and i = j ⇔ j = i\end{matrix}$$

Computing Scores from Pairwise Comparisons

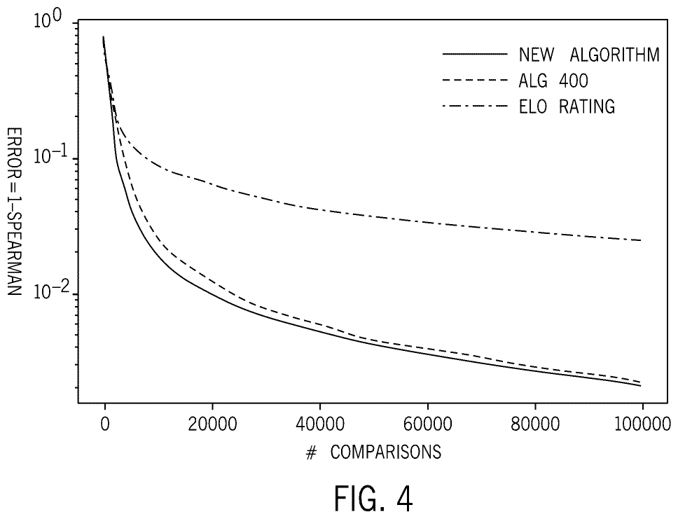

There are multiple ways to compute scores {sᵢ}ᵢ₌₁^{k} from a list of outcomes Lₙ={oᵢ}ᵢ₌₀ⁿ. From the world of chess, two popular methods is the “ELO-rating” and the “Algorithm of 400”. Both of these scores are built on the assumption that the intrinsic skill of a player will change over time. For that reason, a third algorithm may be utilized, which is a development of “the rule of 400”, but where the intrinsic value of an item is assumed to be constant, so that the timing of an outcome does not matter. As an example, imagine four matches between players i and j, where j wins the first 2, and i wins the remaining 2. In the chess formulation, i should have a higher score than j after the 4 matches as he has recently been winning every time. In the new formulation, they should be given the same score as the quality of the players is assumed to be the same in all 4 matches. This is more appropriate when comparing, for example, images 34A to each other, where the image 34A is not changing over time, than for chess, where one would indeed expect that the skill of a player improves over time. FIG. 4 illustrates the convergence of the different algorithms.

### ELO-Rating

The rating of a player may be computed as:
A player i with 0 matches gets an initial score of Rᵢ←1500.
After a match with another player j with a score Rⱼ, Rᵢ may be updated so that:

$${R}_{i} ← {R}_{i} + K \cdot ( {S}_{i} - {E}_{i} ) ,$$

where
   K is the adjustment factor, with K=16 for masters, and K=32 for the rest.
   Sᵢ is the score for player i of the game, with
      Sᵢ=0 if i lost
      Sᵢ=0.5 if draw
      Sᵢ=1 if i won

$${E}_{i} = {( 1 + 1 {0}^{\frac{{R}_{i} - {R}_{j}}{400}} )}^{- 1}$$

is the expected probability that i would win, previous to the match.

### Algorithm of 400

As described above, an alternative algorithm, referred to as the “Algorithm of 400” may be used. For simplicity of discussion, 400 will be replaced with 1. The main idea is that a player should have a score that is approximatively 1 point larger than the players it wins against, 1 point less than the players it loses against, and approximatively equal to the players it plays to a draw against. Assuming a player i saves all his outcomes in three lists L_{w}={sⱼ}ⱼ₌₁ⁿ^{_{w}}, L_{d}={sⱼ}ⱼ₌₁ⁿ^{_{d}}, Lₗ={sⱼ}ⱼ₌₁ⁿ^{ₗ} containing the scores of its opponents at the time of the match, for which the player won, played to a draw, and lost, the player can compute his score as following:

$${s}_{i} = \frac{{Σ}_{j = 1}^{{n}_{w}} ( {s}_{j} + 1 ) + {Σ}_{j = 1}^{{n}_{d}} {s}_{j} + {Σ}_{j = 1}^{{n}_{l}} ( {s}_{j} - 1 )}{{n}_{w} + {n}_{d} + {n}_{l}}$$

As an example, imagine that a player i plays 3 matches, where the score of the players are {1,2,4} and the outcomes for player i are {win, draw, lost}. This gives player i a score of:

$${S}_{i} = \frac{( 1 + 1 ) + ( 2 ) + ( 4 - 1 )}{3} \approx 2.33$$

Note that these scores are computed with the opponents' scores at the time of the encounter. The advantage of this is that each player can compute his own score with no other information than the scores of the opponents at the time of the match. The drawback is that the score cannot use information about future comparison an opponent would be involved in. As an example:
Imagine two new players (i, j), which get initial scores of 0.
They play a match and player i wins.
This outcome gives them scores: sᵢ=1, sⱼ=−1.
Player j then goes on to win against player k with a score sₖ=4. Player j has, thus, lost a match against a player of score 0 (the initial score of player i), and won against a player of score 4.

$${s}_{j} ← \frac{( 0 - 1 ) + ( 4 + 1 )}{2} = 2$$

This gives a new score.
This means that player i now has a lower score than player j, since sᵢ<sⱼ, even though i won against j and that is the only information we have about player i.

Another consequence of only using the score at the time of the match is that the order of the match plays a big role. Imagine that i and j play 2 matches where i wins the first but loses the second. One might expect that the two players have equal skill, but according to this formulation, this is not the case. Assume both players starts with score 0.
After the first match, the players have scores sᵢ=1, sⱼ=−1.
After the second match:

$${s}_{i} = \frac{( 0 + 1 ) + ( - 1 - 1 )}{2} = - 0.5$$

$${s}_{j} = \frac{( 0 - 1 ) + ( 1 + 1 )}{2} = 0.5$$

It is worth noting, however, that if the two players would play infinitely many matches, with equal probability for each one winning, then their scores would converge to the same score.

### New Time-Independent Version of the “Algorithm of 400”

A modified version of the Algorithm of 400 has been developed, with the difference that the timing of a comparison has no effect, which is more appropriate when the intrinsic value of an object is assumed to be constant over time. The basic idea is the same, but:
Instead of using the opponents' score at the time of the comparison, the current score of all objects may be used.
A bias of α>0 may be added, to be interpreted as each object having compared equal once with an objects with score 0. This can be seen as the initialization value of each player, so that a score is defined even for players with no comparisons. If nothing else is indicated, α may be assumed to be 1.

Given a score sᵢ for a player i:

$${s}_{i} = \frac{{Σ}_{j = 1}^{k} ( {s}_{j} - 1 ) {n}_{i < j} + ( {s}_{j} + 1 ) {n}_{i > j} + {s}_{j} {n}_{i = j}}{α + {Σ}_{j = 1}^{k} {n}_{i j}}$$

where, as before, n_{i*j} is the number of times the outcome i*j has been observed, and:

$${n}_{i j} = {n}_{i < j} + {n}_{i > j} + {n}_{i = j}$$

This can be rewritten as:

$${s}_{i} = \frac{{Σ}_{j = 1}^{k} {s}_{j} {n}_{i j} + ( {n}_{i > j} - {n}_{i < j} )}{α + {Σ}_{j = 1}^{k} {n}_{i j}}$$

To compute this, the expression may be rewritten in matrix form to get equation:

$$( I α + diag ( N 1 ) ) s = Ns + ( {N}_{>} - {N}_{<} ) 1 \qquad ( 1 )$$

Where diag(x) is a diagonal matrix with the vector x over the diagonal, and:

$$1 = [ \begin{matrix}1 \\ 1 \\ ⋮ \\ 1\end{matrix} ] , \qquad s = [ \begin{matrix}{s}_{1} \\ {s}_{2} \\ ⋮ \\ {s}_{k}\end{matrix} ]$$

and:

$$N = {N}_{<} + {N}_{>} + {N}_{=}$$

and:

$${N}_{*} = [ \begin{matrix}{n}_{1 * 1} & {n}_{1 * 2} & … & {n}_{1 * k} \\ {n}_{2 * 1} & {n}_{2 * 2} & … & {n}_{2 * k} \\ ⋮ & ⋮ & ⋱ & ⋮ \\ {n}_{k * 1} & {n}_{k * 2} & … & {n}_{k * k}\end{matrix} ] \qquad ( 2 )$$

Because of symmetries, it is noted that:

$${N}_{=}^{T} = {N}_{=}$$

since i=j⇔j=i, and:

$${N}_{<}^{T} = {N}_{>}$$

since i>j⇔j<i.

We also note that N1 represents the number of comparisons/object, since:

$$N 1 = {\sum }_{j = 1}^{k} [ \begin{matrix}{n}_{1 j} \\ {n}_{2 j} \\ ⋮ \\ {n}_{kj}\end{matrix} ]$$

To compute the scores given equation (1):

$$s = {( I α + diag ( N 1 ) - N )}^{- 1} ( {N}_{>} - {N}_{<} ) 1$$

or:

$$s = {A}^{- 1} b \qquad ( 3 )$$

with:

$$A = I α + diag ( N 1 ) - N \qquad ( 4 )$$

and:

$$b = ( {N}_{>} - {N}_{<} ) 1 \qquad ( 5 )$$

A key question here is if the matrix A is invertible.

### Proof—Matrix A is Invertible

A matrix A is invertible if and only if it is positive definite, meaning that x^{T} Ax>0, for any vector x≠0. This can be seen by splitting:

$$A = I α + B$$

with:

$$B = diag ( N 1 ) - N$$

or:

$$B = [ \begin{matrix}{\sum }_{j \neq 1} {n}_{1 j} & - {n}_{12} & … & - {n}_{1 k} \\ - {n}_{21} & {\sum }_{j \neq 2} {n}_{2 j} & … & - {n}_{2 k} \\ ⋮ & ⋮ & ⋱ & ⋮ \\ - {n}_{k 1} & - {n}_{k 2} & … & {\sum }_{j \neq k} {n}_{kj}\end{matrix} ]$$

where E_{j≠i} indicates that j goes from 1 to k while skipping the i:th term. Now:

$${x}^{⊤} ( I α + B ) x = {x}^{⊤} x α + {x}^{⊤} Bx \qquad ( 6 )$$

Since x≠0 and α>0, it follows that:

$${x}^{⊤} x α > 0 \qquad ( 7 )$$

We now turn our attention to the second term of (6). With x=[x₁ x₂ . . . xₖ]^{T} we can expand:

$${x}^{⊤} Bx = {\sum }_{i = 1}^{k} {\sum }_{j \neq i} {x}_{i} ( {x}_{i} - {x}_{j} ) {n}_{ij} \qquad ( 8 )$$

By using Σᵢ₌₁^{k}Σ_{j≠i}=Σⱼ₌₁^{k}Σ_{i≠j}, swapping the notation i and j, and using nᵢⱼ=nⱼᵢ, it can be re-written as:

$${x}^{⊤} Bx = {\sum }_{i = 1}^{k} {\sum }_{j \neq i} {x}_{j} ( {x}_{j} - {x}_{i} ) {n}_{ij} \qquad ( 9 )$$

Adding (8) and (9) together:

$$2 {x}^{⊤} Bx = {\sum }_{i = 1}^{k} {\sum }_{j \neq i} ( {x}_{i}^{2} + {x}_{j}^{2} - 2 {x}_{i} {x}_{j} ) {n}_{ij} \\ 2 {x}^{⊤} Bx = {\sum }_{i = 1}^{k} {\sum }_{j \neq i} {( {x}_{i} - {x}_{j} )}^{2} {n}_{ij}$$

Since each element (xᵢ-xⱼ)²nᵢⱼ≥0, it follows that x^{T}Bx≥0. From equation (6) and (7), it thus follows that

x^{T}Ax>0

Meaning that A is positive definite and thus invertible.

### Batch Formalization

One disadvantage of this algorithm compared to the original is that it is necessary to invert a matrix of size k×k. For relatively large k, this inversion could take some time. In a scenario where it is necessary to compute scores quickly, it could therefore make sense to only compute the scores of a subset of all the objects/players, that is, compute the scores for a batch of all objects/players. This may cause problems. Imagine that (1,2) and (2,3) have been compared, and now a batch with 1 and 3 is desired. There is no comparison of the two. Therefore, it is important to determine how to include information from their encounter with object 2.

One way to do this, given a batch of size h<k with objects B={i₁, i₂, . . . , iₕ}, is to assign all objects not in the batch to an “outsider cluster”, which is denoted as an object i_{*.} Using this idea, batch matrices may be determined:

$${N}_{*}^{B} = [ \begin{matrix}{n}_{{i}_{1} * {i}_{1}} & {n}_{{i}_{1} * {i}_{2}} & … & {n}_{{i}_{1} * {i}_{h}} & {\sum }_{j ∉ B} {n}_{{i}_{1} * j} \\ {n}_{{i}_{2} * {i}_{1}} & {n}_{{i}_{2} * {i}_{2}} & … & {n}_{{i}_{2} * {i}_{h}} & {\sum }_{j ∉ B} {n}_{{i}_{2} * j} \\ ⋮ & ⋮ & ⋱ & ⋮ & ⋮ \\ {n}_{{i}_{h} * {i}_{1}} & {n}_{{i}_{h} * {i}_{2}} & … & {n}_{{i}_{h} * {i}_{h}} & {\sum }_{j ∉ B} {n}_{{i}_{2} * j} \\ {\sum }_{j ∉ B} {n}_{j * {i}_{1}} & {\sum }_{j ∉ B} {n}_{j * {i}_{2}} & … & {\sum }_{j ∉ B} {n}_{j * {i}_{h}} & {\sum }_{i ∉ B} {\sum }_{j ∉ B} {n}_{i * j}\end{matrix} ]$$

To give a concrete example, assume there are 4 objects, of which the first and the third are in the batch. Then, for some outcome *∈[<, =, >] the following results:

$${N}_{*} = [ \begin{matrix}1 & 2 & 3 & 4 \\ 5 & 6 & 7 & 8 \\ 9 & 10 & 11 & 12 \\ 13 & 14 & 15 & 16\end{matrix} ] ⇒ {N}_{*}^{\{ 1 , 3 \}} = [ \begin{matrix}1 & 3 & 2 + 4 \\ 9 & 11 & 6 + 8 \\ 5 + 13 & 6 + 14 & 6 + 8 + 14 + 16\end{matrix} ]$$

The scores of the batch may be computed using the matrices N_{<}^{B}, N_{>}^{B}, N₌^{B} using equation (3). This gives us h+1 scores, where the last score is the score of all objects outside the batch.

### Comparison of Algorithms

To see the differences between the algorithms, they may be compared to each other in a scenario where 1000 simulated players are playing 100,000 matches, where each match is between two randomly selected players. Each player i has a simulated skill in the form of a normal distribution N(μᵢ, θᵢ). In a match between player i and j a value vᵢ˜N(μᵢ, σᵢ), vⱼ˜N (μⱼ, θⱼ) is drawn from each.
If vᵢ>vⱼ; +ϵ, player i wins,
If vⱼ>vᵢ+ε, player j wins,
Otherwise it is a draw.

When generating the players, μᵢ; ˜U(0,1) and σᵢ˜U(0.02, .12), where U(a, b) is a uniform distribution between a and b. For comparisons, ϵ=0.1 was chosen.

The results may be seen in FIG. 4. The y-axis shows how closely the ordering of scores sᵢ correspond to the ordering of intrinsic values μᵢ. It can be seen that the new algorithm converges with the algorithm of 400 as the number of comparisons goes to infinity. The new algorithm outperforms the other in the short run, however, as its error is lower in the short run. The error is here computed as 1 minus the spearman loss. The ELO-rating performs considerably worse than the other two. In this case, K=32 was used.

The embodiments described herein enable annotators 50 to select between two content items 34 that the annotators 50 believe is more relevant to a particular criterion. As such, the embodiments described herein eliminate the need for annotators 50 to assign a subjective score to the content items 34 relative to the particular criterion. Rather, over time, the selections of one of two content items 34 at a time relative to the particular criterion may be analyzed to determine which content items 34 are more relevant to the particular criterion.

In addition, the embodiments described herein are extremely efficient insofar as annotators 50 can typically make decisions as described herein in less than a second. During 10 minutes of focused work, one annotator 50 could, thus, make 600 comparisons, giving 1,200 labels (since each comparison gives information about two content items 34). Given 10 annotators and a goal of 10 labels/content item, the annotators 50 could complete a dataset of 600 content items 34 in 10 minutes. It is also noted that this scales linearly, with 6,000 content items 34 in 100 minutes of focused work.

While embodiments have been described herein, those skilled in the art, having benefit of this disclosure, will appreciate that other embodiments are envisioned that do not depart from the inventive scope. Accordingly, the scope of the present claims or any subsequent claims shall not be unduly limited by the description of the embodiments described herein.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. § 112 (f). However, for any claims containing elements designated in any other manner, it is intended that such elements are not to be interpreted under 35 U.S.C. § 112 (f).

What is claimed is:

1. A method, comprising:
presenting two content items of a plurality of content items via a user interface of a web-based application;
receiving, via the user interface of a web-based application, an annotation relating to an indication of which of the two content items are associated with a criterion; and
updating a score relating to the criterion for each of the plurality of content items based at last in part on the annotation.

2. The method of claim 1, wherein the plurality of content items comprise images.

3. The method of claim 1, wherein the plurality of content items comprise video.

4. The method of claim 1, wherein the plurality of content items comprise audio.

5. The method of claim 1, wherein the criterion relates to a smell of the plurality of content items, a taste of the plurality of content items, or a feel of the plurality of content items.

6. The method of claim 1, comprising training a first artificial intelligence (AI) model to determine trends with a plurality of annotations of the plurality of content items associated with the criterion.

7. The method of claim 6, comprising training a second AI model to utilize information learned by the first AI model to automatically, without human intervention, annotate the plurality of content items based on the learned information.

8. A system, comprising:
a memory storing processor-executable instructions; and
one or more processors configured to execute the processor-executable instructions, wherein the processor-executable instructions, when executed by the one or more processors, cause the system to:
cause two content items of a plurality of content items to be presented via a user interface of a web-based application;
receive an annotation relating to an indication of which of the two content items are associated with a criterion; and
update a score relating to the criterion for each of the plurality of content items based at last in part on the annotation.

9. The system of claim 8, wherein the plurality of content items comprise images.

10. The system of claim 8, wherein the plurality of content items comprise video.

11. The system of claim 8, wherein the plurality of content items comprise audio.

12. The system of claim 8, wherein the criterion relates to a smell of the plurality of content items, a taste of the plurality of content items, or a feel of the plurality of content items.

13. The system of claim 8, wherein the processor-executable instructions, when executed by the one or more processors, cause the system to train a first artificial intelligence (AI) model to determine trends with a plurality of annotations of the plurality of content items associated with the criterion.

14. The system of claim 13, wherein the processor-executable instructions, when executed by the one or more processors, cause the system to train a second AI model to utilize information learned by the first AI model to automatically, without human intervention, annotate the plurality of content items based on the learned information.

15. One or more non-transitory computer-readable memory media, comprising:
processor-executable instructions that, when executed by one or more processors, cause the one or more processors to:
cause two content items of a plurality of content items to be presented via a user interface of a web-based application;
receive an annotation relating to an indication of which of the two content items are associated with a criterion; and
update a score relating to the criterion for each of the plurality of content items based at last in part on the annotation.

16. The one or more non-transitory computer-readable memory media of claim 15, wherein the plurality of content items comprise images.

17. The one or more non-transitory computer-readable memory media of claim 15, wherein the plurality of content items comprise video.

18. The one or more non-transitory computer-readable memory media of claim 15, wherein the plurality of content items comprise audio.

19. The one or more non-transitory computer-readable memory media of claim 15, wherein the criterion relates to a smell of the plurality of content items, a taste of the plurality of content items, or a feel of the plurality of content items.

20. The one or more non-transitory computer-readable memory media of claim 15, wherein the processor-executable instructions, when executed by the one or more processors, cause the one or more processors to train a first artificial intelligence (AI) model to determine trends with a plurality of annotations of the plurality of content items associated with the criterion.

21. The one or more non-transitory computer-readable memory media of claim 20, wherein the processor-executable instructions, when executed by the one or more processors, cause the one or more processors to train a second AI model to utilize information learned by the first AI model to automatically, without human intervention, annotate the plurality of content items based on the learned information.
